(19) United States
(12) Patent Application Publication
(10) Pub. No.: US 2026/0366450 A1
(43) Pub. Date: Nov. 19, 2026

(54) CAB HEATING UTILIZING THE WASTE HEAT RECOVERED USING THE CHARGED AIR FROM THE TURBO OUTLET BEFORE A CHARGE AIR COOLER INLET

(71) Applicant: Volvo Truck Corporation, GÖTEBORG (SE)

(72) Inventors: Jeeva Rajasekar PALANIVEL, Bangalore (IN); Karthikeyan THANGARAJ, Tirunelveli (IN)

(21) Appl. No.: 19/155,341

(22) PCT Filed: Feb. 15, 2023
(86) PCT No.: PCT/IB2023/051373

§ 371 Date: Aug. 11, 2025

(51) Int. Cl. F01P 3/20; B60H 1/04; B60S 1/02; F01P 3/12; F02B 29/04

(52) U.S. Cl. CPC F01P 3/20; B60H 1/04; B60S 1/023; F01P 3/12; F02B 29/045; F01P 2060/02; F01P 2060/12; F01P 2060/18

(57) ABSTRACT

An internal heat exchanger (IHE) positioned between a turbocharger of an engine and a charge air cooler, the IHE comprising: an engine coolant in port for receiving engine coolant; an engine coolant out port for outputting heated engine coolant to a heater core of a vehicle; an engine coolant channel between the engine coolant in port and the engine coolant out port; at least one air passageway between a first end of the IHE, through the engine coolant channel, to a second end of the IHE and configured to receive charged air from the turbocharger and flow the charged air through the at least one air passageway, wherein heat from the charged air is transferred via a wall of the at least one air passageway to the engine coolant flowing through the engine coolant channel, thereby providing heated engine coolant at the engine coolant out port.

### TECHNICAL FIELD

The disclosure relates generally to vehicle cab heating. In particular aspects, the disclosure relates to cab heating utilizing the waste hear recovered using the charged air from the turbo outlet before a charge air cooler inlet. The disclosure can be applied in heavy-duty vehicles, such as trucks, buses, and construction equipment. Although the disclosure may be described with respect to a particular vehicle, the disclosure is not restricted to any particular vehicle.

### BACKGROUND

During cold start and cold environment conditions in order to meet target requirement like cabin warmup, defrosting and others is highly critical, engine coolant with or without pump for coolant flow into the heater core will not give effective result.

During cold start at freezing temperature, the engine coolant also will be at the freezing temperature. It will take some time to get warm, at that condition, even if more coolant is pumped (higher flowrate) into the Cabin by an electric pump will also not give required results.

Currently, the traditional way is to use charged air cooler for cooling the compressed air from turbo and heating the cabin using the hot coolant coming from engine and an additional electric heater to meet the cabin warmup requirements.

### SUMMARY

According to a first aspect of the disclosure, an internal heat exchanger positioned between a turbocharger of an engine and a charge air cooler is provided. The internal heat exchanger includes an engine coolant in port for receiving engine coolant; an engine coolant out port for outputting heated engine coolant to a heater core of a vehicle; an engine coolant channel that extends between the engine coolant in port and the engine coolant out port; and at least one air passageway that extends between a first end of the internal heat exchanger, through the engine coolant channel, to a second end of the internal heat exchanger and configured to receive charged air from the turbocharger and flow the charges air through the at least one air passageway, wherein heat from the charged air flowing through the engine coolant channel is transferred from the charged air via a wall of the at least one air passageway to the engine coolant flowing through the engine coolant channel, thereby providing heated engine coolant at the engine coolant out port. The first aspect of the disclosure may seek to meet cabin warmup, defrost and other requirements effectively at freezing ambient temperature conditions and during cold start conditions by heating the engine coolant from the warmer charged air from the turbocharger. A technical benefit may include reducing, and in some cases, eliminating the need for an auxiliary pump and electric power source. This first aspect can provide better usage of waste heat from the charged air coming out from the turbo outlet.

In some examples, the at least one air passageway is a plurality of channels of a length based on performance requirements. A technical benefit may include providing more surface area to heat the engine coolant, which can speed up heating of the cab.

In some examples, the plurality of channels are parallel to each other. A technical benefit may include enabling more channels to be used, thereby providing more surface area to heat the engine coolant.

In some examples, the plurality of channels is a plurality of tubes. A technical benefit may include using off-the-shelf tubes that may reduce cost of the internal heat exchanger.

In some examples, the engine coolant in port is located adjacent to a first end of the at least one air passageway and the engine coolant out port is located adjacent to a second end of the at least one air passageway opposite the first end of the at least one air passageway. A technical benefit may be that the engine coolant path around the at least one air passageway is nearly as long as the length of the internal heat exchanger forcing the engine coolant path to flow nearly the length of the internal heat exchanger, thereby maximizing the amount of heat exchange between the warmer air and the engine coolant.

In some examples, during operation of the engine, engine coolant received at the engine coolant in port flows through the engine coolant channel and surrounds the at least one air passageway and flows to the engine coolant out port wherein heat is transferred from the charged air flowing through the at least one air passageway to the engine coolant via a wall of the at least one air passageway. A technical benefit may be that the engine coolant path around the at least one air passageway is nearly as long as the length of the internal heat exchanger forcing the engine coolant path to flow nearly the length of the internal heat exchanger, thereby maximizing the amount of heat exchange between the warmer air and the engine coolant.

In some examples, the internal heat exchanger includes a housing, wherein a first end of the at least one air passageway is connected to a first opening at a first end of the housing and a second end of the at least one air passageway is connected to a second opening at a second end of the housing; and wherein the engine coolant in port is integrally connected to a first opening of the housing located adjacent to the first end of the housing and the engine coolant out port is integrally connected to a second opening of the housing located adjacent to the second end of the housing wherein the engine coolant channel connects the engine coolant in port to the engine coolant out port. A technical benefit may be that the engine coolant path around the at least one air passageway is nearly as long as the length of the internal heat exchanger forcing the engine coolant path to flow nearly the length of the internal heat exchanger, thereby maximizing the amount of heat exchange between the warmer air and the engine coolant.

In some aspects, the engine coolant out port is configured to output heated engine coolant to provide heated engine coolant to the heater core of the vehicle to provide heat to a cab of the vehicle during cold start and freezing atmospheric conditions. A technical benefit may include heating the cab quicker than using unheated engine coolant.

In some aspects, the engine coolant out port is configured to output heated engine coolant to provide heated engine coolant to the heater core of the vehicle to provide heat to defrost a windshield of the vehicle during cold start and freezing atmospheric conditions. A technical benefit may include defrosting the windshield quickly, thereby allowing a driver of the vehicle to see through the windshield.

In some aspects, the engine coolant out port is configured to output heated engine coolant to provide heated engine coolant to the heater core of the vehicle to provide heat to an outside rear view mirror (OVRM) of the vehicle to defrost the OVRM during cold start and freezing atmospheric conditions. A technical benefit may include defrosting the OVRM, thereby allowing a driver of the vehicle to see through the OVRM.

According to a second aspect of the disclosure, a method of operating an internal heat exchanger to provide heated engine coolant for warming a heater core of a vehicle, the method comprising: receiving, from a turbocharger of an engine of the vehicle, charged air; directing the charged air through the at least one air passageway and out of the at least one air passageway towards a charge air cooler of the vehicle; flowing engine coolant from the engine coolant in port of the internal heat exchanger, around the at least one air passageway to transfer heat to the engine coolant, and outputting heated engine coolant at the engine coolant out port to a heater core of the vehicle. The second aspect of the disclosure may seek to meet cabin warmup, defrost and other requirements effectively at freezing ambient temperature conditions and during cold start conditions by heating the engine coolant from the warmer charged air from the turbocharger. A technical benefit may include reducing, and in some cases, eliminating the need for an auxiliary pump and electric power source. This second aspect can provide better usage of waste heat from the charged air coming out from the turbo outlet.

In some examples, the charged air is received by receiving charged air from a charged air passageway between the turbocharger and the charge air cooler. A technical benefit may include having better usage of waste heat from the charged air coming out from the turbo outlet.

In some examples, the heated engine coolant is output at the engine coolant out port to a heater core of the vehicle by outputting heated engine coolant at the engine coolant out port to a heater core of the vehicle to provide heat to a cab of the vehicle during cold start and freezing atmospheric conditions. A technical benefit may include heating the cab quicker than using unheated engine coolant.

In some examples, the heated engine coolant is output at the engine coolant out port to a heater core of the vehicle by outputting heated engine coolant at the engine coolant out port to a heater core of the vehicle to further provide heat to defrost a windshield of the vehicle during cold start and freezing atmospheric conditions. A technical benefit may include defrosting the windshield quicker than using unheated engine coolant so the vehicle driver can see out the windshield.

In some examples, the heated engine coolant is output at the engine coolant out port to a heater core of the vehicle by outputting heated engine coolant at the engine coolant out port to a heater core of the vehicle to further provide heat to an outside rear view mirror (OVRM) of the vehicle to defrost the OVRM during cold start and freezing atmospheric conditions. A technical benefit may include defrosting the OVRM quicker than using unheated engine coolant so the vehicle driver can see out the OVRM.

In some examples, the heated engine coolant is output at the engine coolant out port to a heater core of the vehicle by outputting heated engine coolant at the engine coolant out port to a heater core of the vehicle to further provide heat to a sleeping compartment of the vehicle. A technical benefit may include heating the sleeping compartment quicker than using unheated engine coolant.

In some aspects, the charged air is directed through the at least one air passageway and out of the at least one air passageway towards a charge air cooler of the vehicle by cooling the charged air flowing through the at least one air passageway by transferring heat from the charged air to the engine coolant. A technical benefit may include heating the engine coolant quicker by transferring some of the heat from the charged air to the engine coolant. The charger air cooler may be reduced in size since some of the heat has been transferred to the engine coolant.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIGS. 1A and 1B are an exemplary view of a vehicle in which the internal heat exchanger may be implanted within according to one example.

FIG. 2 is an exemplary view of where the internal heat exchanger may be located withing the vehicle of FIG. 1 according to one example.

FIG. 3A is an another view of the internal heat exchanger of FIG. 2 according to an example.

FIG. 3B is a view of the internal heat exchanger of FIG. 2 along line A-A according to an example.

FIG. 4 is a cross-sectional view of the internal heat exchanger of FIG. 2 according to an example.

FIG. 5 is cut-away view of the internal heat exchanger of FIG. 2 according to another example.

FIGS. 6-10 are flowcharts of operations the internal heat exchanger performs according to examples.

FIG. 11 is another view of the internal heat exchanger of FIG. 2.

### DETAILED DESCRIPTION

Aspects set forth below represent information for enabling those skilled in the art to practice the disclosure.

Currently, the traditional way is to use the charged air cooler for cooling the compressed air from turbo and heating the vehicle cabin using the hot coolant coming from engine and an additional electric heater to meet the vehicle cabin warmup requirements.

During cold start at freezing temperature, the engine coolant also will be at the freezing temperature, so it will take time to heat the vehicle cabin. Using an additional electric heater to heat the vehicle cabin while waiting for the engine coolant to warm up draws battery energy and can be inefficient.

According to an inventive concept, waste heat from the turbocharger of a vehicle engine is used to heat the engine coolant using an internal heat exchanger. Heating the engine coolant during a cold start may decrease the time it takes for the engine coolant to warm up.

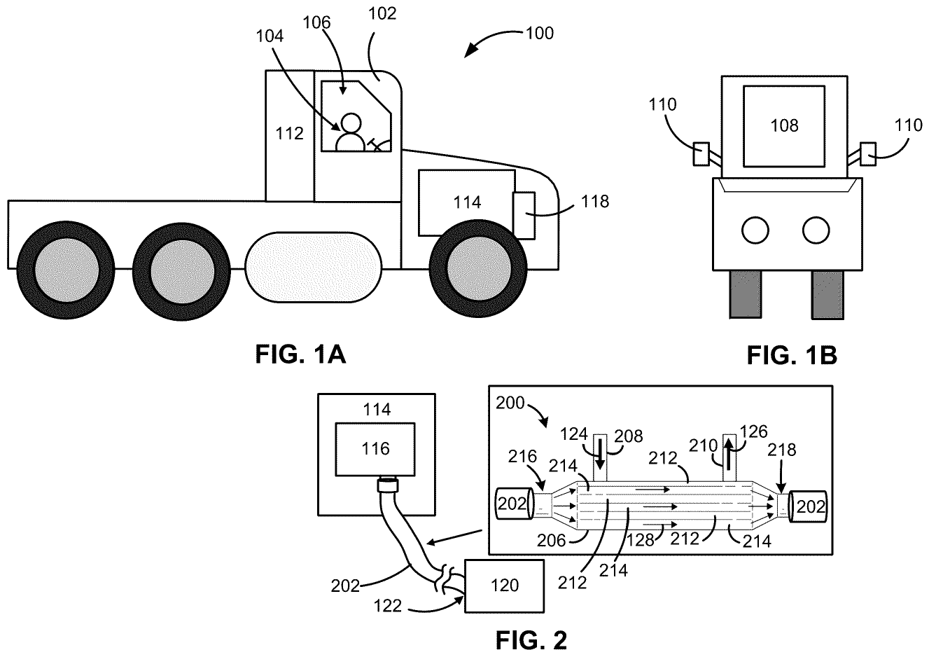

FIG. 1 is an exemplary environment in which the internal heat exchanger may operation according to one example. Turning to FIG. 1, a truck 100 having a cab 102 used by a vehicle user 104 sitting in the interior of the cab 106 is shown. The cab 106 has a windshield 108 and outside rear view mirrors 110. In some embodiments, the vehicle may have a sleeping compartment 112. The vehicle has an engine 114 with a turbocharger 116 and a heater core 118.

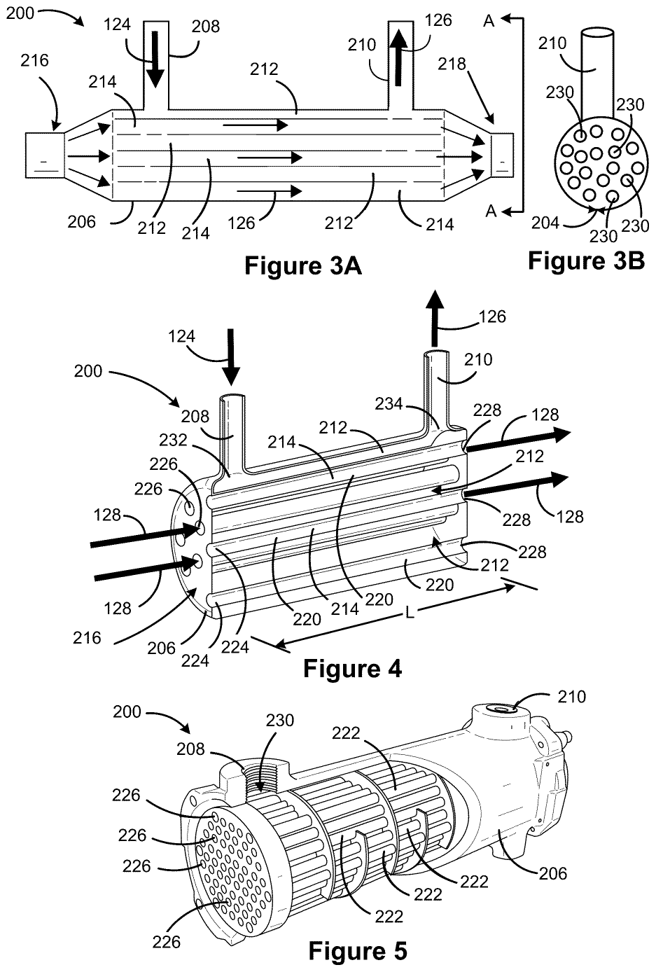

FIGS. 2-5 illustrate an internal heat exchanger 200 that is placed between the turbocharger 116 and a charge air cooler (CAC) 120 of the vehicle 100. In some aspects, the internal heat exchanger 200 is placed in line with a charged air passageway 202 (e.g., a hose) going between the turbocharger and the CAC. In these aspects, the circumference 204 (see FIG. 3B) of the housing 206 is sized to be connected to the charged air passageway 202 between the turbocharger and the charge air cooler.

The internal heat exchanger 200 has an engine coolant in port 208 for receiving engine coolant and an engine coolant out port 210 for outputting heated engine coolant to a heater core 118 of a vehicle 100 and an engine coolant passageway 212. The internal heat exchanger 200 also has at least one air passageway 214 between a first end 216 of the internal heat exchanger 200 and a second end 218 of the of the internal heat exchanger 200 and located within the engine coolant passageway 212. The heat from the charged air 128 flowing through the at least one air passageway 214 heats the engine coolant 124 flowing around the at least one air passageway 214 by transferring heat from the charged air 128 to the engine coolant 124 to provide heated engine coolant 126 at the engine coolant out port 210. This can result in the charged air 128 flowing out of the internal heat exchanger 200 being cooler than the charged air flowing into the internal heat exchanger 200. In some aspects as illustrated in FIG. 4, the at least one air passageway is a plurality of channels 220 of a length L based on performance requirements.

In some aspects, the plurality of channels is a plurality of tubes 222 (See FIG. 5). The tubes may be commercially available off-the-shelf tubes.

A first end 224 of the at least one air passageway 214 is connected at a first opening 226 to a first end 216 of the housing and a second end 228 of the at least one air passageway 214 is connected at a second opening 230 to a second end 218 of the housing 206. The engine coolant in port 208 is integrally connected to a first opening 232 of the housing 206 located adjacent to the first end 216 of the housing 206 and the engine coolant out port 210 is integrally connected to a second opening 234 of the housing 206 located adjacent to the second end 218 of the housing.

The engine coolant in port 208 is located adjacent the first end 216 of the at least one air passageway 214 and the engine coolant out port 210 is located adjacent to the second end 218 opposite the first end 216 of the at least one air passageway 214. This allows, during operation of the engine 114, the engine coolant 124 at the engine coolant in port 208 to flow through the engine coolant passageway 212 while surrounding the at least one air passageway 214 (e.g., the plurality of channels 220) to the engine coolant out port 210 and be heated by the charged air 128 flowing through the at least one air passageway 214 via the wall of the at least one air passageway 214.

The engine coolant out port 210 is configured to output heated engine coolant 126 to provide heated engine coolant 126 to the heater core 118 of the vehicle to provide heat to a cab 106 of the vehicle 100 during cold start and freezing atmospheric conditions. In some aspects, the engine coolant out port 210 is configured to output heated engine coolant 126 to provide heated engine coolant 126 to the heater core 118 of the vehicle 10 to provide heat to defrost a windshield 108 of the vehicle 100 during cold start and freezing atmospheric conditions. In some other aspects, the engine coolant out port 210 is configured to output heated engine coolant 126 to provide heated engine coolant 126 to the heater core 118 of the vehicle 100 to provide heat to an outside rear view mirror (OVRM) 110 of the vehicle to defrost the OVRM 110 during cold start and freezing atmospheric conditions.

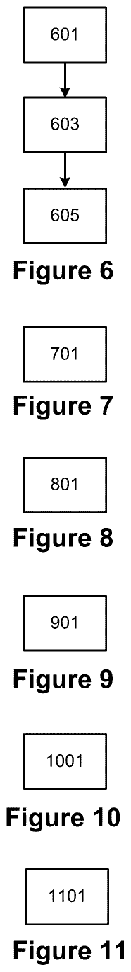

FIG. 6 illustrates operations the internal heat exchanger 200 performs during cold start conditions. Turning to FIG. 6, during operation, the internal heat exchanger 200 in block 601 receives, from a turbocharger 116 of an engine 114 of the vehicle 100, charged air 128. In an aspect, the internal heat exchanger 200 receives the charged air by receiving charged air from a charged air passageway 202 between the turbocharger 116 and the charge air cooler 120.

In block 603, the internal heat exchanger 200 directs the charged air 128 through the at least one air passageway 214 and out of the at least one air passageway 214 towards a charge air cooler 120 of the vehicle 100. In one aspect, the at least one air passageway 214 comprises a plurality of air passageways 214 and the engine coolant 124 from the engine coolant in port 208 of the internal heat exchanger 200 is flowed around the plurality of air passageways 214.

In block 605, the internal heat exchanger 200 flows engine coolant 124 from the engine coolant in port 208 of the internal heat exchanger 200 through an engine coolant passageway 212 surrounding the at least one air passageway 214 to transfer heat from the charged air 128 to the engine coolant 124, 126, and outputting heated engine coolant 126 at the engine coolant out port 210 towards a heater core 118 of the vehicle 100. In an aspect as illustrated by block 701 of FIG. 7, directing the charged air 128 through the at least one air passageway 214 and out of the at least one air passageway 214 towards a charge air cooler 120 of the vehicle 100 comprises cooling the charged air 128 flowing through the at least one air passageway 214 by transferring heat from the charged air 128 to the engine coolant 124 flowing through the engine coolant channel 212.

Turning to FIG. 8, in an aspect as illustrated by block 801, the internal heat exchanger 200 outputs heated engine coolant 126 at the engine coolant out port 210 to a heater core 118 of the vehicle 100 by outputting heated engine coolant 126 at the engine coolant out port 210 to the heater core 118 of the vehicle 100 to further provide heat to a cab 102 of the vehicle 100 during cold start and freezing atmospheric conditions.

Turning to FIG. 9, in another aspect as illustrated by block 901, the internal heat exchanger 200 outputs heated engine coolant 126 at the engine coolant out port 210 to a heater core 118 of the vehicle 100 by outputting heated engine coolant 126 at the engine coolant out port 210 to the heater core 118 of the vehicle 100 to further provide heat to defrost a windshield 108 of the vehicle 100 during cold start and freezing atmospheric conditions.

Turning to FIG. 10, in a further aspect as illustrated by block 1001, the internal heat exchanger 200 outputs heated engine coolant 126 at the engine coolant out port 210 to the heater core 118 of the vehicle 100 by outputting heated engine coolant 126 at the engine coolant out port 210 to the heater core 118 of the vehicle 100 to further provide heat to an outside rear view mirror (OVRM) 110 of the vehicle 100 to defrost the OVRM 110 during cold start and freezing atmospheric conditions.

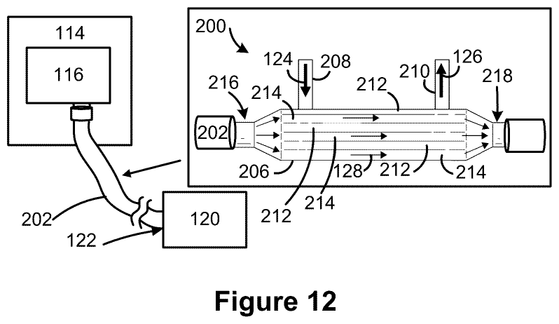

Turning to FIG. 11, in a further aspect as illustrated by block 1101, the internal heat exchanger 200 outputs heated engine coolant 126 at the engine coolant out port 210 to the heater core 118 of the vehicle 100 by outputting heated engine coolant 126 at the engine coolant out port 210 to the heater core 118 of the vehicle 100 to further provide heat to a sleeping compartment of the vehicle.

FIG. 12 is another view of FIG. 2, according to another example. The internal heat exchanger 200 positioned between a turbocharger 116 of an engine 114 and a charge air cooler 120, the internal heat exchanger 200 includes an engine coolant in port 208 for receiving engine coolant 124. The An engine coolant out port 210 for outputting heated engine coolant 126 to a heater core 118 of a vehicle 100. The internal heat exchanger 200 further includes at least one air passageway 214 between the turbocharger 116 and a charge air inlet 122 of the charge air cooler 120 and configured to receive charged air 128 from the turbocharger, heat the engine coolant contacting the at least one air passageway by transferring heat from the charged air 128 to provide heated engine coolant 126 at the engine coolant out port 210, and output the charged air 128 to the charge air cooler 120.

Examples of the internal heat exchanger are provided below.

Example 1: An internal heat exchanger 200 positioned between a turbocharger 116 of an engine 114 and a charge air cooler 120, the internal heat exchanger comprising:
an engine coolant in port 208 for receiving engine coolant 124;
an engine coolant out port 210 for outputting heated engine coolant 126 to a heater core 118 of a vehicle;
an engine coolant channel 212 that extends between the engine coolant in port 208 and the engine coolant out port 210;
at least one air passageway 214 that extends between a first end 216 of the internal heat exchanger 200, through the engine coolant channel 212, to a second end 218 of the internal heat exchanger 200 and configured to receive charged air 128 from the turbocharger (116) and flow the charged air 128 through the at least one air passageway 214, wherein heat from the charged air 128 flowing through the at least one air passageway 214 is transferred from the charged air 128 via a wall of the at least one air passageway 214 to the engine coolant 124 flowing through the engine coolant channel 212, thereby providing heated engine coolant (126) at the engine coolant out port (210).

Example 2. The internal heat exchanger of example 1, wherein the at least one air passageway 214 comprises a plurality of channels 220 of a length (L) based on performance requirements.

Example 3. The internal heat exchanger of example 2, wherein the plurality of channels 220 are parallel to each other.

Example 4. The internal heat exchanger of example 3, wherein the plurality of channels comprises a plurality of tubes 222.

Example 5. The internal heat exchanger of any of examples 1-4, wherein the engine coolant in port 208 is located adjacent to a first end 216 of the at least one air passageway 214 and the engine coolant out port 210 is located adjacent to a second end 218 of the at least one air passageway 214 opposite the first end 216 of the at least one air passageway 214.

Example 6. The internal heat exchanger of example 5 wherein during operation of the engine 114, engine coolant 124 in port 208 flows through the engine coolant channel 212 and surrounds the at least one air passageway 214 to the engine coolant out port 210 where heat is transferred from the charged air 128 flowing through the at least one air passageway 214 to the engine coolant 124 via a wall of the at least one air passageway 214.

Example 7. The internal heat exchanger of any of examples 1-6, further comprising a housing 206,
wherein a first end 224 of the at least one air passageway 214 is connected at a first opening 226 at a first end 216 of the housing 206 and a second end 228 of the at least one air passageway 214 is connected at a second opening 230 at a second end 218 of the housing 206; and
wherein the engine coolant in port 208 is integrally connected to a first opening 232 of the housing 206 located adjacent to the first end 216 of the housing 206 and the engine coolant out port 210 is integrally connected to a second opening 234 of the housing 206 located adjacent to the second end 218 of the housing 206 where the engine coolant channel 212 connects the engine coolant in port 208 to the engine coolant out port 210.

Example 8. The internal heat exchanger of any of examples 1-7 wherein the engine coolant out port 210 is configured to output heated engine coolant 126 to provide heated engine coolant 126 to the heater core 118 of the vehicle 100 to provide heat to a cab 102 of the vehicle 100 during cold start and freezing atmospheric conditions.

Example 9. The internal heat exchanger of any of examples 1-8 wherein the engine coolant out port 210 is configured to output heated engine coolant 126 to provide heated engine coolant 126 to the heater core 118 of the vehicle 100 to provide heat to defrost a windshield 108 of the vehicle 100 during cold start and freezing atmospheric conditions.

Example 10. The internal heat exchanger of any of claims 1-8 wherein the engine coolant out port 210 is configured to output heated engine coolant 126 to provide heated engine coolant 126 to the heater core 118 of the vehicle 100 to provide heat to an outside rear view mirror (OVRM) 110 of the vehicle 100 to defrost the OVRM 110 during cold start and freezing atmospheric conditions.

Example 11. The internal heat exchanger of any of claims 1-8 wherein the engine coolant out port 210 is configured to output heated engine coolant 126 to provide heated engine coolant 126 to the heater core 118 of the vehicle 100 to provide heat to a sleeping compartment 112 of the vehicle 100.

Example 12. A vehicle 100 having a turbocharger 116, a charge air cooler 120 and an internal heat exchanger 200 according to any of examples 1-11 between the turbocharger 116 and the charge air cooler 120.

Example 13. A method of operating an internal heat exchanger 200 according to any of examples 1-8, the internal heat exchanger 200 to provide heated engine coolant 126 for warming a heater core 118 of a vehicle 100, the method comprising:
receiving (601), from a turbocharger (116) of an engine (114) of the vehicle 100, charged air 128;
directing (603) the charged air 128 through the at least one air passageway 214 and out of the at least one air passageway 214 towards a charge air cooler 120 of the vehicle 100;
flowing (605) engine coolant 124 from the engine coolant in port 208 of the internal heat exchanger 200, through an engine coolant channel surrounding the at least one air passageway 214 to transfer heat from the charged air 128 to the engine coolant 124, and outputting heated engine coolant 126 at the engine coolant out port 210 towards a heater core 118 of the vehicle 100.

Example 14. The method of example 13, wherein receiving the charged air 128 comprises receiving charged air 128 from a charged air passageway 202 between the turbocharger 116 and the charge air cooler 120.

Example 15. The method of any of examples 13-14, wherein directing the charged air 128 through the at least one air passageway 214 and out of the at least one air passageway 214 towards a charge air cooler 120 of the vehicle 100 comprises cooling (701) the charged air 128 flowing through the at least one air passageway 214 by transferring heat from the charged air 128 to the engine coolant 124 flowing through the engine coolant channel 212.

Example 16. The method of any of examples 13-15 wherein outputting heated engine coolant 126 at the engine coolant out port 210 to a heater core 118 of the vehicle 100 comprises outputting (801) heated engine coolant 126 at the engine coolant out port 210 to a heater core 118 of the vehicle 100 to further provide heat to a cab 102 of the vehicle 100 during cold start and freezing atmospheric conditions.

Example 17. The method of examples 13-16, wherein outputting heated engine coolant 126 at the engine coolant out port 210 to a heater core 118 of the vehicle 100 comprises outputting (901) heated engine coolant 126 at the engine coolant out port 210 to a heater core 118 of the vehicle 100 to further provide heat to defrost a windshield 108 of the vehicle 100 during cold start and freezing atmospheric conditions.

Example 18. The method of any of examples 13-17, wherein outputting heated engine coolant 126 at the engine coolant out port 210 to a heater core 118 of the vehicle 100 comprises outputting (1001) heated engine coolant 126 at the engine coolant out port 210 to a heater core 118 of the vehicle 100 to further provide heat to an outside rear view mirror (OVRM) 110 of the vehicle 100 to defrost the OVRM 110 during cold start and freezing atmospheric conditions.

Example 19. The method of any of examples 13-18, wherein the at least one air passageway 214 comprises a plurality of air passageways and flowing engine coolant 124 from the engine coolant in port 208 of the internal heat exchanger 200 comprises flowing the engine coolant 124 around the plurality of air passageways 214.

Example 20. The method of any of examples 13-19, wherein receiving (601), from the turbocharger 116 of an engine 114 of the vehicle 100, charged air 128 comprises receiving the charged air 128 in a charged air passageway 202 between the turbocharger 116 and a charged air cooler 120.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms.

These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

What is claimed is:

1. An internal heat exchanger positioned between a turbocharger of an engine and a charge air cooler, the internal heat exchanger comprising:
an engine coolant in port for receiving engine coolant;
an engine coolant out port for outputting heated engine coolant to a heater core of a vehicle;
an engine coolant channel that extends between the engine coolant in port and the engine coolant out port;
at least one air passageway that extends between a first end of the internal heat exchanger, through the engine coolant channel, to a second end of the internal heat exchanger and configured to receive charged air from the turbocharger and flow the charged air through the at least one air passageway, wherein heat from the charged air flowing through the at least one air passageway is transferred from the charged air via a wall of the at least one air passageway to the engine coolant flowing through the engine coolant channel, thereby providing heated engine coolant at the engine coolant out port.

2. The internal heat exchanger of claim 1, wherein the at least one air passageway comprises a plurality of channels of a length (L) based on performance requirements.

3. The internal heat exchanger of claim 2, wherein the plurality of channels are parallel to each other.

4. The internal heat exchanger of claim 3, wherein the plurality of channels comprises a plurality of tubes.

5. The internal heat exchanger of claim 1, wherein the engine coolant in port is located adjacent to the first end of the at least one air passageway and the engine coolant out port is located adjacent to the second end of the at least one air passageway opposite the first end of the at least one air passageway.

6. The internal heat exchanger of claim 5 wherein during operation of the engine, engine coolant received at the engine coolant in port flows through the engine coolant channel and surrounds the at least one air passageway and flows to the engine coolant out port wherein heat is transferred from the charged air flowing through the at least one air passageway to the engine coolant via a wall of the at least one air passageway.

7. The internal heat exchanger of claim 1, further comprising a housing,
wherein a first end of the at least one air passageway is connected at a first opening at a first end of the housing and a second end (228) of the at least one air passageway is connected at a second opening at a second end of the housing; and
wherein the engine coolant in port is integrally connected to a first opening (232) of the housing located adjacent to the first end of the housing and the engine coolant out port is integrally connected to a second opening (234) of the housing located adjacent to the second end of the housing wherein the engine coolant channel connects the engine coolant in port to the engine coolant out port.

8. The internal heat exchanger of claim 1 wherein the engine coolant out port is configured to output heated engine coolant to provide heated engine coolant to the heater core of the vehicle to provide heat to a cab of the vehicle during cold start and freezing atmospheric conditions.

9. The internal heat exchanger of claim 1 wherein the engine coolant out port is configured to output heated engine coolant to provide heated engine coolant to the heater core of the vehicle to provide heat to defrost a windshield of the vehicle during cold start and freezing atmospheric conditions.

10. The internal heat exchanger of claim 1 wherein the engine coolant out port is configured to output heated engine coolant to provide heated engine coolant to the heater core of the vehicle to provide heat to an outside rear view mirror (OVRM) of the vehicle to defrost the OVRM during cold start and freezing atmospheric conditions.

11. The internal heat exchanger of claim 1 wherein the engine coolant out port is configured to output heated engine coolant to provide heated engine coolant to the heater core of the vehicle to provide heat to a sleeping compartment (112) of the vehicle.

12. A vehicle having a turbocharger, a charge air cooler and an internal heat exchanger according to claim 1 between the turbocharger and the change air cooler.

13. A method of operating an internal heat exchanger according to claim 1, the internal heat exchanger to provide heated engine coolant for warming a heater core of a vehicle, the method comprising:
receiving, from a turbocharger of an engine of the vehicle, charged air;
directing the charged air through the at least one air passageway and out of the at least one air passageway towards a charge air cooler of the vehicle;
flowing engine coolant from the engine coolant in port of the internal heat exchanger, through an engine coolant channel surrounding the at least one air passageway to transfer heat from the charged air to the engine coolant, and outputting heated engine coolant at the engine coolant out port towards a heater core of the vehicle.

14. The method of claim 13, wherein receiving the charged air comprises receiving charged air from a charged air passageway between the turbocharger and the charge air cooler.

15. The method of claim 13, wherein directing the charged air through the at least one air passageway and out of the at least one air passageway towards a charge air cooler of the vehicle comprises cooling (701) the charged air flowing through the at least one air passageway by transferring heat from the charged air to the engine coolant flowing through the engine coolant channel.

16. The method of claim 13 wherein outputting heated engine coolant at the engine coolant out port to a heater core of the vehicle comprises outputting heated engine coolant at the engine coolant out port 210 to a heater core of the vehicle to further provide heat to a cab of the vehicle during cold start and freezing atmospheric conditions.

17. The method of claim 13, wherein outputting heated engine coolant at the engine coolant out port to a heater core of the vehicle comprises outputting heated engine coolant at the engine coolant out port to a heater core of the vehicle to further provide heat to defrost a windshield of the vehicle during cold start and freezing atmospheric conditions.

18. The method of claim 13, wherein outputting heated engine coolant at the engine coolant out port to a heater core of the vehicle comprises outputting heated engine coolant at the engine coolant out port to a heater core of the vehicle to further provide heat to an outside rear view mirror (OVRM) of the vehicle to defrost the OVRM during cold start and freezing atmospheric conditions.

19. The method of claim 13, wherein the at least one air passageway comprises a plurality of air passageways and flowing engine coolant from the engine coolant in port of the internal heat exchanger comprises flowing the engine coolant around the plurality of air passageways.

20. The method of claim 13, wherein receiving, from the turbocharger of an engine of the vehicle, charged air comprises receiving the charged air in a charged air passageway (202) between the turbocharger and a charged air cooler.
